(19) United States
(12) Patent Application Publication
(10) Pub. No.: US 2026/0259330 A1
(43) Pub. Date: Sep. 3, 2026

(54) SYSTEM AND METHOD FOR IMPROVED ESTIMATION OF SPATIALLY-VARIANT GNSS SIGNAL CORRECTIONS

(71) Applicant: Swift Navigation, Inc., San Francisco, CA (US)

(72) Inventors: Matthew Peddie, San Francisco, CA (US); Alexander Thomas Kleeman, San Francisco, CA (US)

(73) Assignee: Swift Navigation, Inc., San Francisco, CA (US)

(21) Appl. No.: 19/552,125

(22) Filed: Feb. 27, 2026

Related U.S. Application Data
(60) Provisional application No. 63/765,415, filed on Feb. 28, 2025.

(51) Int. Cl. G01S 19/07; G01S 19/23

(52) U.S. Cl. CPC G01S 19/072; G01S 19/23

(57) ABSTRACT

A method for generating ionospheric GNSS corrections can include: receiving satellite observations from one or more reference stations; determining ionosphere observables and associated pierce points on an atmospheric shell; fitting a regression model to estimate an ionospheric correction field; and outputting model parameters for a receiver to determine a corrected ionospheric delay.

### CROSS-REFERENCE TO RELATED APPLICATIONS

This application claims the benefit of U.S. Provisional Application No. 63/765,415 filed 28 Feb. 2025, which is incorporated in its entirety by this reference.

### TECHNICAL FIELD

This invention relates generally to the satellite positioning field, and more specifically to a new and useful system and method in the satellite positioning field.

### BACKGROUND

In a dense Gaussian Process, posterior predictions are made directly from all of the training data, using the inverse (in implementation, the decomposition) of the covariance matrix of all the training data. Inverting (decomposing) the full covariance takes processor time proportional to the cube of the number of training data, after which predictions take time in proportion to the square of the number of training data. In satellite positioning applications, the amount of training data can grow rapidly as additional reference stations, satellites, frequencies, and/or epochs are incorporated (e.g., to improve accuracy, integrity, coverage, and/or update rate). This growth can make dense Gaussian Process fitting and prediction computationally impractical for real-time and/or high-throughput corrections generation. In particular, the cubic scaling for model fitting and the quadratic scaling for prediction can limit the ability to ingest more satellite observations and/or to update corrections at low latency as data volume increases. Therefore, to leverage Gaussian processes for the prediction of corrections for satellite positioning applications, there is the need in the satellite positioning field to create a new and useful system and method. This invention provides such a new and useful system and method.

### BRIEF DESCRIPTION OF THE FIGURES

FIG. 1 is a chart representation of a method of an invention embodiment.

FIG. 2 is a schematic representation of an example of a computing system for determining GNSS corrections.

FIGS. 3A and 3B are example representations of atmospheric effect (e.g., ionospheric effect) model parameters.

FIG. 3C is a schematic representation of an example of a coordinate system used in embodiments of an atmospheric effects model, where the origin can refer to the center of the earth or any suitable reference point.

FIG. 4 is a schematic representation of an example of a system.

FIG. 5A-5C are schematic representations examples of inducing points distributions relative to blocks.

FIG. 6 is a schematic representation of an example workflow for estimating corrections.

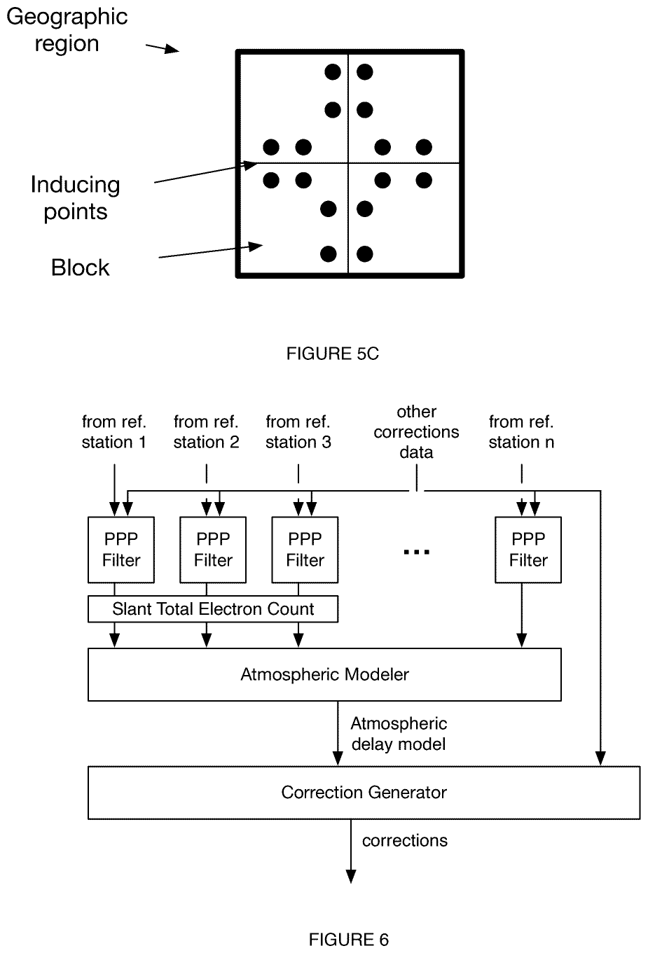

FIG. 7 is a schematic representation of an example of warping.

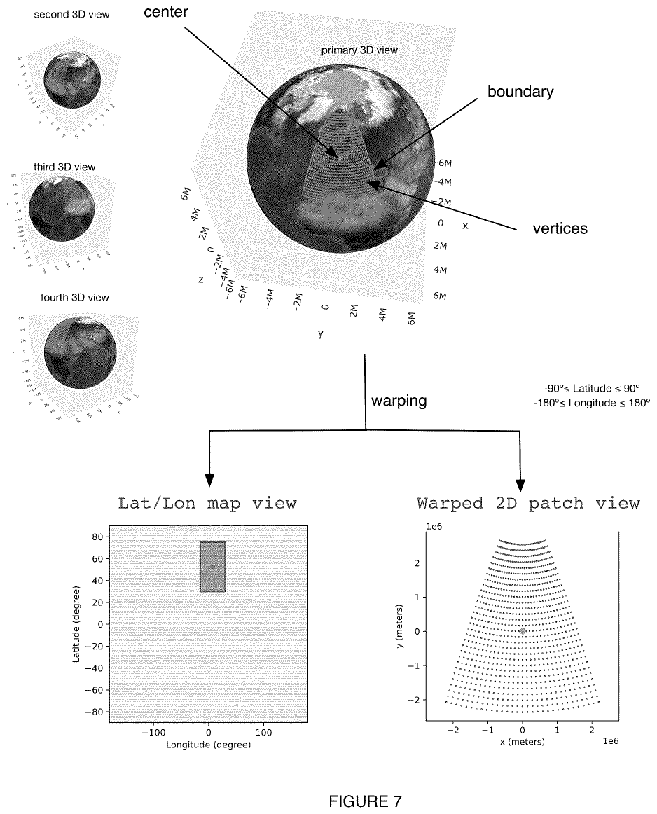

FIG. 8 is a schematic representation of an example of spectral decomposition.

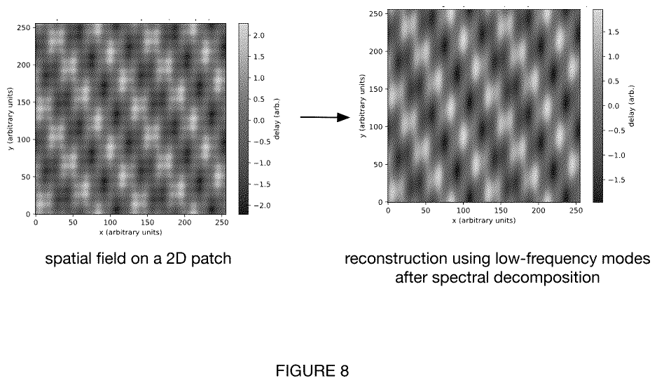

### DETAILED DESCRIPTION

The following description of the invention embodiments of the invention is not intended to limit the invention to these invention embodiments, but rather to enable any person skilled in the art to make and use this invention.

### 1. Overview

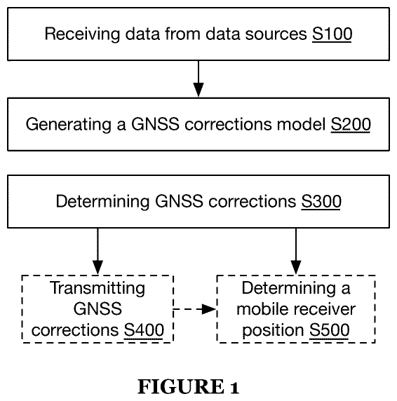

As shown in FIG. 1, a method for generating GNSS corrections can include: receiving data S100, determining a GNSS corrections model S200, and determining GNSS corrections S300. The method can optionally include: transmitting the GNSS corrections S400, determining a mobile receiver position S500, and/or any suitable steps. The data preferably corresponds to a set of satellite observations (e.g., pseudorange, carrier phase, ephemeris, code data, etc.), corresponding to one or more satellites of one or more satellite constellations, detected at a set of reference stations, detected at other satellites (e.g., low earth orbit satellites), and/or detected at any suitable detection site. However, the data can additionally or alternatively include sensor data, weather conditions (e.g., temperature, humidity, wind, etc.), and/or any suitable data.

As used herein, spatially-variant GNSS corrections can include corrections that depend on at least one of receiver location, satellite line-of-sight geometry (e.g., elevation and/or azimuth), time, and/or an atmospheric pierce point, including corrections represented on a grid or tile, as parameters of a basis expansion, and/or as a state-space representation (SSR).

A pierce point (also referred to as an ionospheric pierce point) can refer to an artificial spatial point defined by intersecting a line-of-sight path between a receiver (e.g., a reference station or a mobile receiver) and a satellite with an atmospheric shell and/or ionospheric layer. In variants, an atmospheric shell can be modeled as a spherical surface at a selected altitude (and/or a set of shells at multiple altitudes) that approximates a portion of the ionosphere. A geographic region can refer to a spatial area over which the GNSS corrections model is fit and/or over which continuity of corrections is maintained. In variants, the geographic region can be partitioned into a plurality of geographic tiles (also referred to as blocks or subregions), where each tile is associated with a subset of training measurements and/or a local representation of the correction field. Reduced spatial correlation anisotropy (and/or reduced anisotropy) can refer to producing a coordinate representation and/or modeled correction field in which correlation structure is less direction-dependent, for example by reducing directional dependence of residual correlation (e.g., residual variogram dependence on azimuth), reducing a ratio of principal correlation-length scales, and/or reducing cross-validation error associated with structured directional residuals.

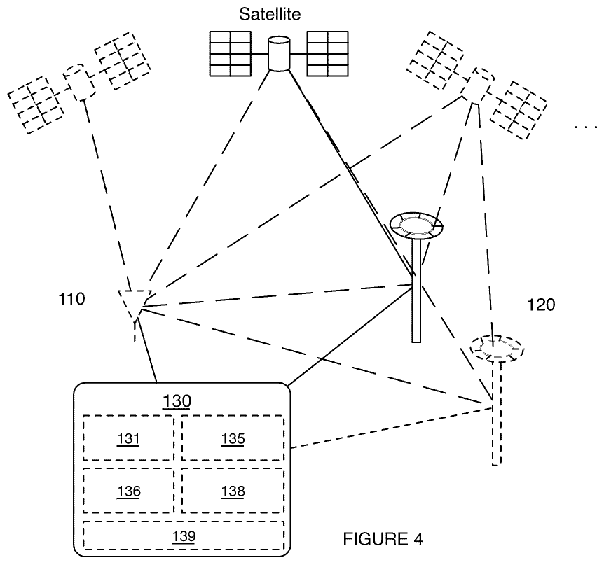

As shown in FIG. 4, a system for generating GNSS corrections can include: one or more mobile receivers, a set of reference stations, and a computing system. The system can optionally include sensors.

The system and/or method preferably function to determine GNSS corrections, which can be used to correct satellite observations and/or mobile receiver positions to increase the accuracy and/or integrity of a mobile receiver position. Variants of the system and/or method are particularly beneficial for determining spatially varying GNSS corrections such as atmospheric corrections (e.g., ionospheric delay, tropospheric delay, etc.), ocean tide effects, and/or to estimate values for other spatially-variant error sources.

Embodiments of the system and/or method can be used, for example, in autonomous or semi-autonomous vehicle guidance (e.g., for unmanned aerial vehicles (UAVs), unmanned aerial systems (UAS), self-driving cars, agricultural equipment, robotics, rail transport/transit systems, autonomous trucking, last mile delivery, etc.), GPS/GNSS research, surveying systems, user devices, mobile applications, internet-of-things (IOT) devices, and/or may be used in any other suitable application. In specific examples, the system (and/or components) can be coupled to any suitable external system such as a vehicle (e.g., UAV, UAS, car, truck, etc.), robot, railcar, user device (e.g., cell phone), and/or any suitable system, and can provide positioning data, integrity data (e.g., protection level data), and/or other data to said system.

In a specific example, the system and/or method can include receiving a set of satellite observations corresponding to one or more satellites associated with one or more satellite constellation; generating a set of GNSS corrections (e.g., ionosphere delays) using a sparse Gaussian process (preferably using a partially independent conditional (PIC) approximation).

### 2. Technical Advantages

Variants of the technology can confer one or more advantages over conventional technologies.

First, variants of the technology can enable greater quantities of data sources to be ingested by a corrections generator without significantly increasing the amount of time required to estimate the GNSS corrections and/or without significantly impacting a fidelity of the estimated GNSS corrections. In one specific example, the use of a sparse Gaussian process (in particular one using a partially independent training conditional approximation) with inducing points selected based on a spatial partition of a geographical region can enable improved speed in the estimations without significantly impacting an accuracy of the estimations (e.g., as compared to performing a full Gaussian process without approximations).

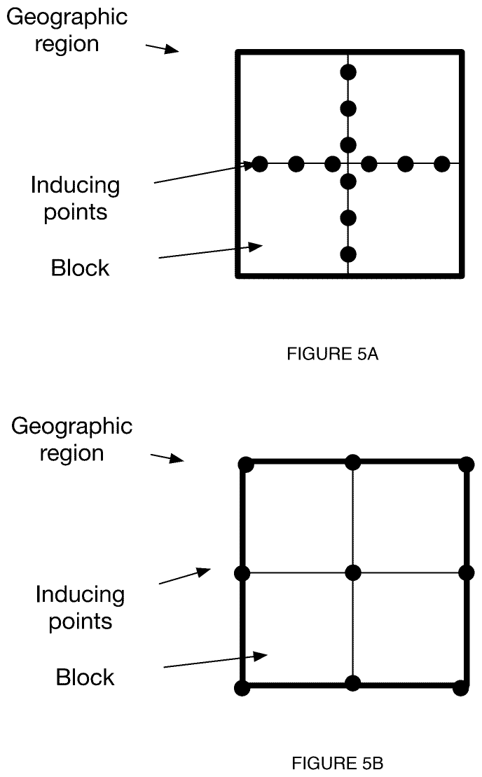

Second, variants of the technology can enable generation of GNSS corrections that remain consistent across a large geographic region without introduction of discontinuities across spatial regions. For example, selecting inducing points proximal to (e.g., on as shown for example in FIG. 5A, adjacent to as shown for example in FIG. 5C) and/or distributed across a geographical region (as shown for example in FIG. 5B) can result in a sparse Gaussian process that enables GNSS correction determination with minimal introduction of discontinuities at the boundaries between spatial regions within the geographical region.

Third, variants of the invention can enable doubling or even greater increases in the number of data sources used to generate GNSS corrections. Normally, one would expect scaling O(N³) so doubling the number of data sources would be expected to almost 10× the amount of time required to generate the model (predictions once the model is generated can be completed in O(N) for a predictive mean for a single query and O(N²) for a predictive variance and/or jointly predicting a batch of query locations). In variants that leverage sparse Gaussian processes (particularly using PIC assumptions), the scaling for fitting the model can be O(NM²+M³) (where M is the number of ‘inducing points’), optionally with additional per-group terms

$$( e . g . , {Σ}_{b} 0 ( {n}_{b}^{3} )$$

for group sizes n_{b}, where Σ_{b} n_{b}=N) in block-structured implementations, enabling significantly faster computations. Similarly, the time scaling for predictions using these models can be O((M+B)²) (where B is a number of independent groupings in the model). The inventors have found that variants of the method that leverage these approximations (i.e., a PIC sparse Gaussian model) enable significantly improved modeling speeds without significantly compromising the model fidelity and/or accuracy and can further enable larger networks of data sources to be used (which can in turn further improve accuracy).

Fourth, variants that use spectral representations for tomographic kernels can reduce computational cost by computing per-path spectral features once (e.g., φ(P;ω)) and by replacing a dense quadratic double integral representation of tomographic covariance with an outer spectral sampling/integration, thereby improving runtime and/or enabling higher measurement throughput. Additionally or alternatively, the reduced cost can be traded for higher-fidelity tomographic modeling (e.g., more shells, more vertical degrees of freedom, finer spatial resolution, etc.) while maintaining a target runtime and/or measurement throughput.

Fifth, variants that represent receiver and/or satellite bias terms as structured symmetric products (e.g., QQ^{T}, optionally under permutation) can incorporate bias states efficiently within an augmented system and can exploit sparsity in bias columns as network density increases, thereby improving scalability for large multi-station, multi-satellite datasets.

Sixth, variants that define temporal covariance between spectral coefficients can enable updating (e.g., rebasing such as changing the representation and/or anchor points of the approximate posterior, time updating, etc.) of spectral inducing points across epochs, supporting time-evolving atmospheric corrections (e.g., temporal TEC) without requiring recomputation at each epoch.

Seventh, variants that represent atmospheric corrections using a truncated spectral basis can reduce computational cost relative to dense Gaussian process inference by converting model fitting into a basis-parameter estimation problem. In a specific example, the atmospheric field (e.g., VTEC, STEC, ionospheric delay, etc.) is represented as a truncated expansion with M retained modes, and N ionosphere observables are used as training measurements (where M and N are both integers and M<N). In this example, the atmospheric field forms a feature vector per measurement (e.g., φ(xᵢ) evaluated at a warped pierce point xᵢ) and assembles a design matrix Φ∈R^{N×M}, which can be performed in processor time O(NM) (e.g., one O(M) feature evaluation per measurement). The coefficient fit can be performed by solving a regularized least-squares (and/or Bayesian linear regression or other regression) problem in M unknowns, which in a general implementation can be performed in O(M³) after forming normal equations. In some variants (e.g., by using diagonal or block-diagonal spectral priors, iterative solvers that use matrix-vector products with Φ, etc.), the coefficient fit can be performed in O(I×NM+M²) (where I is an iteration count). These variants can additionally or alternatively enable amortized updates when streaming new data. After coefficients are determined, evaluation at a receiver pierce point can be performed using a dot product of length M, yielding per-query runtime O(M) for a predicted correction mean, and O(M²) when additionally computing a predictive variance and/or confidence metric from an M×M coefficient covariance. Accordingly, the spectral approach can provide improved scalability and higher measurement throughput while preserving controllable fidelity via the truncation order M.

However, further advantages can be provided by the system and method disclosed herein.

### 3. Method

As shown in FIG. 1, a method for generating GNSS corrections can include: receiving data S100, determining a GNSS corrections model S200, and determining GNSS corrections S300. The method can optionally include: transmitting the GNSS corrections S400, determining a mobile receiver position S500, and/or any suitable steps. The data preferably corresponds to a set of satellite observations (e.g., pseudorange, carrier phase, ephemeris, code data, etc.), corresponding to one or more satellites of one or more satellite constellations, detected at a set of reference stations, detected at other satellites (e.g., low earth orbit satellites), and/or detected at any suitable detection site. However, the data can additionally or alternatively include sensor data, weather conditions (e.g., temperature, humidity, wind, etc.), and/or any suitable data.

The method preferably functions to determine GNSS corrections and/or estimate (e.g., calculate, determine) the position of the mobile receiver using the GNSS corrections. Steps and/or substeps of the method can be performed iteratively (e.g., for different epochs, for the same epoch, etc.), sequentially, and/or in any suitable order. The steps and/or substeps of the method can be performed in series and/or in parallel. The steps and/or substeps are preferably performed by a system as described above, but can be performed by any system.

Receiving one or more satellite observations S100 preferably functions to track, measure (e.g., at one or more reference stations, at a GNSS receiver of a rover, etc.), and/or access one or more sets of satellite observations (e.g., carrier phase measurements, pseudo-range measurements, code measurements, doppler measurements, etc.) associated with one or more observed satellites. However, S100 can additionally or alternatively include receiving raw satellite signals (and optionally determining satellite observations from the satellite signals). The data sources preferably correspond to reference stations, but can additionally or alternatively include computing systems (e.g., databases, PPP global corrections data sources, etc.) and/or any suitable data sources. S100 can include measuring satellite signals and converting the satellite signals into satellite observations.

S100 can include determining reference-satellite observables (RS observables), which functions to transform measured raw satellite observations into a set of reference-station observables that are (a) less sensitive to nuisance terms (e.g., receiver clock), structured for downstream spatial modeling, and/or can be associated with a warped spatial domain that increases stationarity and/or isotropy of an atmospheric field to be estimated. In preferred variants, determining RS observables is performed after measuring raw satellite observations and before determining atmospheric corrections. In variants, S100 includes determining a plurality of ionosphere observables from the satellite observations. The ionosphere observables can be formed from raw and/or combined measurements (e.g., dual-frequency combinations, geometry-free combinations, and/or other combinations indicative of ionospheric delay), and can be expressed as slant ionospheric delay, slant total electron count (STEC), vertical total electron count (VTEC such as via mapping), ionospheric gradients, and/or other atmospheric observables. In such variants, for each ionosphere observable associated with a respective reference station and a respective satellite, S100 can further include determining a corresponding pierce point on an atmospheric shell, wherein the pierce point corresponds to an intersection between a line-of-sight path between the respective reference station and the respective satellite and the atmospheric shell. In multi-shell variants, the system computes a respective pierce point for each shell of a plurality of shells, enabling shell-parameterized observables and/or jointly-modeled shell fields.

In a first example, measuring raw satellite observations includes measuring pseudorange and/or carrier-phase observations y_{r,s,f}(t) for receiver or reference station r, satellite s, frequency f, and epoch t. Determining RS observables can then include selecting a reference satellite so (e.g., highest elevation, best C/No, lowest predicted multipath, etc.) and forming reference-satellite observables by differencing: Δy_{r,s,f}(t)=y_{r,s,f}(t)−y_{r,s}_{₀}_{,f}(t) for one or more satellites s≠s₀. In variants, the differencing is performed for code, phase, doppler, and/or linear combinations (e.g., geometry-free, ionosphere-free, Melbourne-Wübenna, etc.), and may be performed per-constellation, per-frequency, per-elevation bin, per-time window, and/or per-reference-station.

Determining RS observables can further include warping a spatial domain associated with the measured raw satellite observations (and/or associated pierce points) to produce warped-domain inputs used to define the RS observables and/or used to define a subsequent atmospheric model. In some variants, the RS observables (e.g., combined, differenced, etc. satellite observations) can be warped (instead of warping the raw, undifferenced, uncombined, etc. satellite observations). The warping can include applying a warping function W(⋅) to one or more spatial coordinates associated with the raw satellite observations (e.g., receiver location, satellite line-of-sight intersection points with one or more atmospheric shells, a path parameterization along a line-of-sight ray between the receiver and satellite or reference station and satellite, etc.). In a first variant, W maps Earth-fixed spatial coordinates associated with ionosphere observables (e.g., pierce point coordinates on one or more atmospheric shells, optionally together with epoch time) into an alternative coordinate system selected to more faithfully represent spatial proximity and correlation relationships among the ionosphere observables (e.g., relationships between pierce point locations and corresponding ionospheric delay values), such that downstream modeling assumptions are better satisfied. Faithful representation can refer to producing warped coordinates in which the atmospheric process is better aligned with the spatial dependence assumptions used by a downstream model, such as being more nearly stationary and/or isotropic, exhibiting more homogeneous correlation-length behavior across the geographic region, and/or yielding reduced structured residual correlation and improved predictive performance. In variants, this can be quantified by reducing one or more measured metrics, such as an anisotropy metric (e.g., a ratio of principal correlation-length scales), a nonstationarity metric (e.g., spatial variation in fitted kernel hyperparameters or residual variance), a directional residual-correlation metric (e.g., residual variogram dependence on azimuth), and/or a cross-validation error metric for predicted atmospheric corrections. In a second variant, W can be a time-dependent warp W(p,t) that incorporates an advective or drift component (e.g., a ‘frozen-flow’ style translation) so that the atmospheric field appears more stationary in the warped coordinates across consecutive epochs. In a third variant, W can be a smooth, invertible (e.g., diffeomorphic) mapping parameterized by a set of parameters θ (e.g., spline control points, radial-basis control points, a piecewise-affine mesh, and/or a low-dimensional parametric family), and θ can be determined (e.g., tuned) to increase a stationarity metric, increase an isotropy metric, and/or increase a likelihood of a downstream Gaussian process or spectral model. The warping function can include a diffeomorphic mapping with a Jacobian determinant constrained to exceed a threshold. However, other suitable warp functions can be used.

Determining the warping function can include optimizing parameters of the warping function to reduce a measured anisotropy metric of residuals of the ionosphere observables.

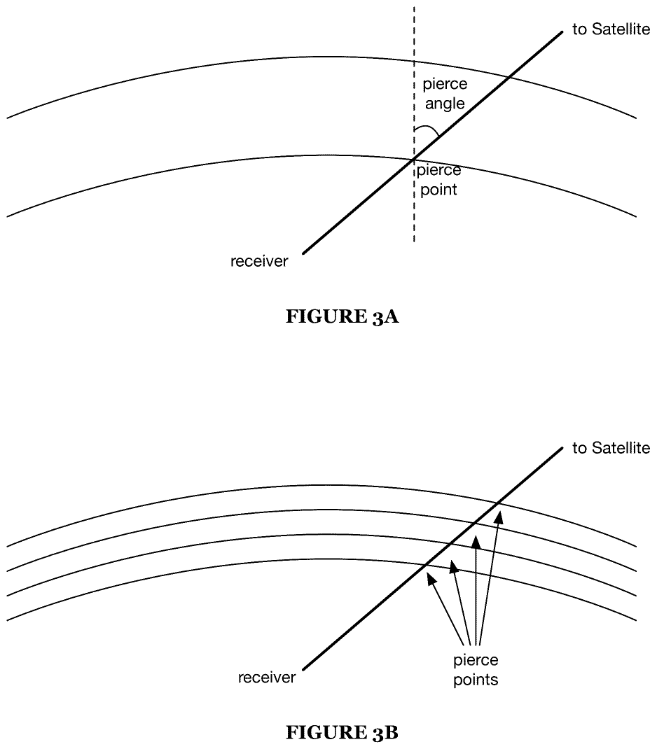

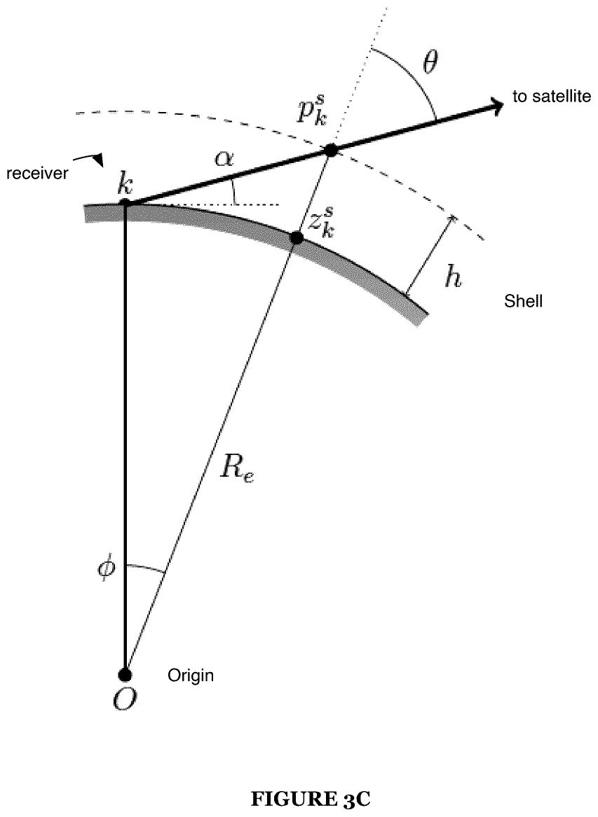

In variants that use a multi-shell implementation, determining RS observables includes computing pierce points for each observation with respect to each shell of a set of shells (as shown for instance in FIG. 3B), and warping each pierce point prior to forming a model input. For example, for shell index k, a pierce point p_{r,s,k}(t) can be computed from receiver position and satellite geometry; warping then yields \tilde{p}_{r,s,k}(t)=W(p_{r,s,k}(t),t). The RS observables can then be associated with the warped pierce points \tilde{p}_{r,s,k}(t) (and/or with warped arc-length parameterizations of the ray) such that subsequent atmospheric corrections are determined as a function of the warped spatial domain.

In variants, the atmospheric correction of interest (e.g., ionospheric TEC, slant delay, etc.) can be observed through tomographic measurements corresponding to a line-of-sight path integral through an unknown spatial density field. In such variants, a tomographic measurement can be modeled as xₜₒₘₒ=∫_{P} ρdx, and the covariance between two tomographic measurements can be written as a double integral of a pointwise spatial kernel along each path.

In further variants, when the pointwise spatial kernel is stationary, the tomographic covariance can be expressed in a Fourier domain representation and rewritten in terms of an explicit path feature map. For example, a feature map can be defined as: φ(P;ω)=∫_{P} e^{-iω·s} ds, so that the tomographic covariance can be represented as an integral (or sampled approximation) over spectral frequencies ω, with each path contributing via φ(P;ω). In such variants, φ(P;ω) can be computed once per path (e.g., via quadrature along the path), and the outer spectral integral can be approximated by sampling, thereby avoiding an explicit quadratic double integral in a dense spatial representation.

In an illustrative example, each path integral can be approximated by an arbitrary quadrature rule with points along the path and associated weights, and the tomographic kernel can be rearranged such that the sum over spectral modes is outermost, yielding path-separable contributions per mode.

The satellite observations are preferably accessed or received by a computing system, but can be accessed by any component. The satellite observations (and/or corrections) can be measured by a set of reference stations (e.g., monitor reference stations, corrections reference stations, etc.), a mobile GNSS receiver, retrieved from a database (e.g., retrieve stored satellite observations; retrieve stored corrections; retrieve an almanac; etc.), low-earth orbit satellites (e.g., for measuring atmospheric delays from a different vantage point), and/or be otherwise received. The satellite observations can include signals from one or more satellite constellations. In some variants, the satellite observations are not combined (e.g., undifferenced satellite observations). In other variants, the satellite observations can be combined (single differenced satellite observations between receivers, single differenced satellite observations between frequencies, single differenced satellite observations between epochs, single differenced satellite observations between satellites, double-differenced satellite observations between receivers and frequencies, double-difference satellite observations between receivers and epochs, double-differenced satellite observations between frequencies and epochs, double differenced satellite observations between receivers and satellites, double differenced satellite observations between frequencies and satellites, triple differenced satellite observations between receivers frequencies and epochs, etc.; combined satellite observations such as to form ionosphere-free combinations, geometry-free combination, wide-lane combination, narrow-lane combination, ultra-wide lane combination, Melbourne-Wübbena combination, group and phase ionospheric calibration combination, etc.; etc.).

Each set of satellite observations preferably includes satellite observations associated with a plurality of satellite constellations. However, one or more sets of satellite observations can correspond to a single satellite constellation.

In some embodiments of the method, the data can be associated with a batch (e.g., set) of data. The data can be batched based on the time of receipt (and/or storage, processing, etc.); a time window during which the data is received (and/or stored, processed, etc.); a location that the data is associated with (e.g., a location of a reference station); and/or be otherwise batched. Each batch of data preferably includes at least 1000 data points (e.g., satellite observations), but can include less than about 1000 data points and/or any number of data points.

Determining a GNSS corrections model S200 can function to determine a GNSS corrections model to use to generate the GNSS corrections, to set parameters and/or hyperparameters of the GNSS correction model (e.g., in response to data received from reference stations), and/or otherwise generate a GNSS corrections model. The GNSS correction model is preferably generated by a correction modeler (e.g., of the computing system), but can be generated by any component. In a set of preferred ionosphere variants, S200 includes determining a spatial ionospheric correction field in a warped coordinate system by fitting a set of parameters of a regression model using the plurality of ionosphere observables associated with warped pierce point coordinates. The regression model can include a Gaussian process model (including sparse approximations thereof), a radial basis function (RBF) regression model, a basis-expansion regression model (including spectral variants described below), and/or other regression models configured to map warped-domain inputs to predicted ionospheric corrections. In variants, the regression model is selected such that, in the warped coordinate system, a spatial model term is more nearly isotropic (e.g., uses an isotropic radial basis function model in the warped coordinate system) and/or yields reduced directional residual correlation. In variants, fitting the regression model includes a regularization term that suppresses higher-order components of the correction field. For example, the regularization term can penalize higher-order spectral components of a spectral decomposition of the spatial ionospheric correction field (e.g., by penalizing large coefficients associated with higher-frequency modes), which can reduce overfitting, stabilize estimation under sparse measurement geometry, and/or improve continuity across the geographic region.

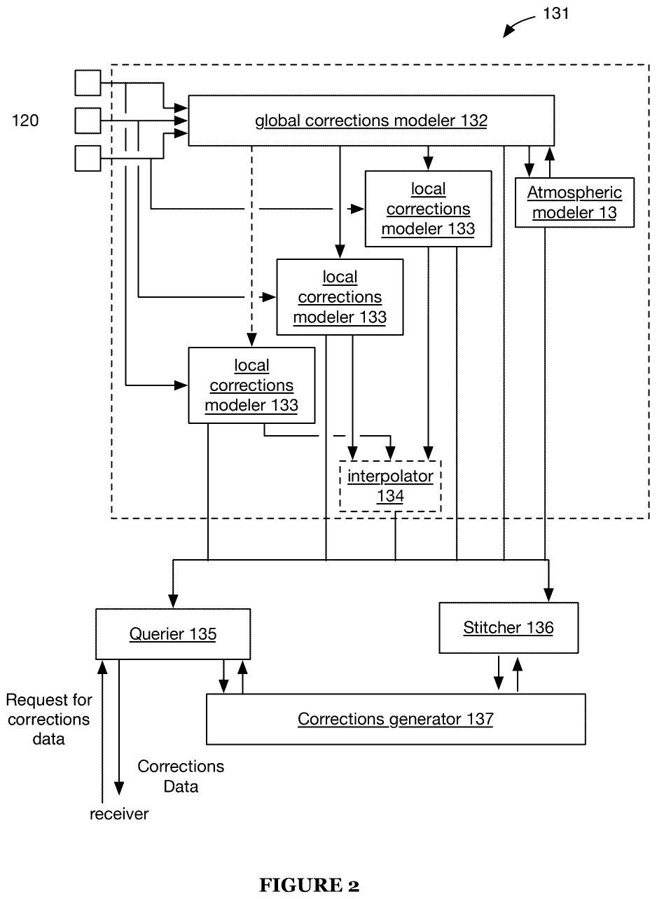

GNSS corrections models can correct for any error source impacting the satellite observations. For example, as described in U.S. patent application Ser. No. 16/195,427 and as shown in FIG. 2, corrections models may be separated into spatially invariant models (which model the effects of global and/or spatially invariant errors on GNSS signals) and spatially variant models (which model local and/or spatially variant effects on GNSS signals and/or effects that are specific to particular receivers/reference stations). Examples of spatially invariant effects include satellite-specific effects (e.g., satellite clock error, satellite orbit error, satellite hardware bias, satellite antenna phase windup, phase center offset (PCO), phase center variation (PCV), etc.), satellite-independent effects (e.g., solid earth tides, solid earth pole tides, ocean tidal loading, etc.), and/or other effects. In some variants, spatially invariant effects can include atmospheric effects (e.g., ionospheric and/or tropospheric effects such as coarse estimates of atmospheric effects for example to be used for initializing a later refinement of the atmospheric effects). Examples of spatially variant effects can include receiver-independent effects (e.g., ionospheric effects such as slant total electron count (STEC) corrections, ionospheric gradients, second-order ionospheric delay, etc.; tropospheric effects such as hydrostatic delay, wet delay, etc.; etc.), receiver-dependent effects (e.g., receiver clock error, receiver hardware bias, receiver antenna phase windup/PCO/PCV, carrier phase ambiguity, multi-path effects, etc.), and/or any spatially variant effects.

The GNSS corrections model can generate the GNSS corrections in batches (e.g., piecewise such as once a predetermined amount of data is available) and/or continuously. The batches can correspond to temporal batches (e.g., using sets of data that are collected within a time window), spatial batches (e.g., using sets of data that are collected within a spatial area), satellite batches (e.g., generated for specific satellites or sets of satellites), satellite constellation batches, reference station batches (e.g., groups of independent reference stations), and/or any suitable batches. The GNSS corrections model can be beneficial for enabling estimation of corrections (e.g., associated with one or more error sources) in a consistent manner (e.g., such that the frequencies can be combined without introducing new errors) for multiple satellite frequencies.

The GNSS corrections model is preferably generated and/or updated using a Gaussian process. The same Gaussian process is preferably used to determine (e.g., estimate) the GNSS correction for each error source (e.g., each error source that is to be accounted for). However, a different Gaussian process can be utilized for subsets of error sources (e.g., a global effect Gaussian process, a local effect Gaussian process, error- or effect-specific Gaussian process(es), etc.), one or more effects and/or errors can be modelled (and/or estimated) using a particle filter (e.g., a Kalman filter, extended Kalman filter, unscented Kalman filters, etc.), one or more effects and/or errors can be modelled (and/or estimated) using machine learning, and/or the effects and/or errors can be estimated in any manner. Here, “using a Gaussian process” preferably refers to fitting one or more Gaussian process models (which make up at least part of GNSS corrections model) based on the data set (e.g., reference station data). It is important to note that many parameter fitting techniques make assumptions based on Gaussian distributions (e.g., Kalman filters assume Gaussian noise). “Gaussian process” is a term of art (referring to a probability distribution over a set of possible functions) and not intended to refer to simply any parameter fitting technique that includes some aspect of Gaussian statistics. However, a Gaussian process can be otherwise defined.

The GNSS correction model preferably uses a sparse approximation to the Gaussian process. Using a sparse approximation to a Gaussian process can provide the benefit of decreasing the computational load which can be particularly beneficial when a large number of data inputs are used. Examples of sparse approximations that can be used include fully independent training conditional (FITC), fully independent conditional (FIC), partially independent training conditional (PITC), partially independent conditional (PIC), using a hierarchy (e.g., plurality) of inducing point layers (e.g., a hierarchical gaussian process (HGP)), a variational free energy (VFE), informative vector machine (IVM), locally independent Gaussian process approximation, patchwork Gaussian process regression, spectral decomposition and/or spectral approximations, Vecchia approximations, conjugate gradient solving, structured Kernel approximations, Markov-structured precision matrices, and/or any suitable sparse approximation to the Gaussian process. In hierarchical variants, the system can use a plurality of inducing-point layers (e.g., coarse-to-fine and/or global-to-local inducing sets), where a higher layer can capture long-range structure and lower layers can capture localized residual structure, thereby improving scalability while preserving multi-scale fidelity. In VFE variants, the system can fit a sparse Gaussian process by optimizing a variational objective (e.g., evidence lower bound) over inducing variables, which enables stable hyperparameter learning and scalable training without requiring full covariance inversion. In IVM variants, the system can incrementally select a subset of training measurements (and/or pseudo-inputs) that maximally reduce posterior uncertainty, enabling online and/or bounded-memory updates as new ionosphere observables stream in. In locally independent Gaussian process variants, the system can partition a geographic region into local neighborhoods (e.g., tiles or clusters) and assumes conditional independence between neighborhoods given a shared global component (and/or given local inducing variables), enabling parallel inference and reduced cross-region coupling cost. In patchwork variants, the system can fit separate local Gaussian process models for different tiles/patches while enforcing cross-patch continuity constraints (e.g., agreement on boundaries and/or shared inducing variables), thereby reducing discontinuities across tiles. In spectral variants, the system can replace dense covariance operations with a truncated basis expansion (e.g., harmonics, Slepian tapers, product bases), estimating a finite set of coefficients from ionosphere observables and evaluating corrections by dot-products at receiver pierce points. Vecchia approximations can approximate the joint Gaussian process distribution by factorizing it into a product of low-dimensional conditional distributions (e.g., conditioning each data point on a limited set of “neighbor” points), thereby yielding a sparse and/or efficiently computable covariance/precision structure. Conjugate gradient solving can compute Gaussian process quantities (e.g., posterior mean terms and/or linear solves of the form K⁻¹y) using iterative matrix-vector products without explicitly forming or decomposing a dense covariance matrix, optionally with preconditioning. Structured Kernel approximations can exploit algebraic structure in the kernel matrix (e.g., Toeplitz/Kronecker structure, low-rank plus diagonal structure, inducing-feature structure, and/or interpolation-based structure) to reduce memory and runtime for training and prediction. Markov-structured precision matrices can represent the Gaussian process (or an approximation thereof) using a sparse precision (inverse covariance) matrix induced by conditional-independence assumptions (e.g., via state-space and/or stochastic partial differential equation representations), enabling sparse linear algebra for inference and updating.

Inputs to the correction model can include: raw satellite signals, undifferenced satellite observations (e.g., pseudorange, carrier phase, code, etc.), uncombined satellite observations, differenced satellite observations (e.g., singled differenced, double differenced, triple differenced, linear combinations, etc.), pierce points, atmospheric delays (e.g., ionosphere delays, troposphere delays, ionosphere gradient, higher order delays, etc. such as modelled using a PPP filter), sensor data (e.g., receiver velocity, receiver vibration, etc.), carrier phase ambiguities (e.g., fixed integer ambiguities, float ambiguities, combined satellite observation ambiguities such as Melbourne Wübbena ambiguities, etc.), corrections (e.g., generated from a different correction model or from a distribution source such as CONUS, particularly but not exclusively for spatially-invariant error terms such as satellite orbit, satellite clock, satellite hardware bias, etc.; where in some instances the corrections like hardware bias could be generated using a Gaussian model such as disclosed in U.S. patent application Ser. No. 18/390,747 titled ‘SYSTEM AND METHOD FOR GAUSSIAN PROCESS ENHANCED GNSS CORRECTIONS GENERATION’ filed 20 Dec. 2023 which is incorporated in its entirety by this reference), inducing points, and/or any data or information. In a first illustrative example, the corrections model can receive (and use without combining, differencing, etc.) undifferenced satellite observations. In a second illustrative example, the corrections model can receive differenced satellite observations (e.g., double frequency combinations, triple frequency combinations, Ionosphere-free combination, Geometry-free combination, wide-lane combinations, narrow-lane combinations, Melbourne-Wübbena combination, Group and Phase Ionospheric Calibration (GRAPHIC) combination, combinations using carrier phase and/or code measurements, Hatch-Melbourne-Wübbena, geometry-free and ionosphere-free combinations, etc.). In a third illustrative example, the corrections model can receive undifferenced satellite observations and compute (as a step in the process of determining the GNSS corrections) differenced or combined satellite observations. In a fourth illustrative example, the corrections model can receive atmospheric observations (e.g., derived from PPP estimates) such as STEC, TEC, ionosphere delays, ionospheric gradients, troposphere delays, and/or other observables.

The Gaussian process is preferably associated with (e.g., depends on) a set of parameters. S200 can include determining the set of parameters. The parameters can be determined (e.g., calculated) in real or near real time, offline, and/or with any timing. The parameters can be determined automatically, semi-automatically, and/or manually. The parameters are preferably retrieved from memory, but can be determined in any manner. The parameters can be static, dynamic, variable, and/or otherwise defined. Examples of parameters can include: covariance function(s), a functional relationship between variables (e.g., a distance function, a time function, etc.), mapping functions, distance functions, pierce points, data inputs, atmospheric shells (e.g., shell thickness, number of shells, type of shell, etc.), hyperparameters, spatio-temporal scales (e.g., spatial, temporal, etc. length scales), inducing points (e.g., number of inducing points, location of spatial location of inducing points, etc.), sub-regions or blocks (e.g., block size, block arrangement, block shape, number of blocks, etc.), and/or any suitable data and/or information. In an illustrative example, parameter covariances may be defined based on a model; e.g., the covariance between ionospheric delay at two positions (e.g., corresponding to two reference stations) may be modeled as a function of the distance between pierce points (where the line of sight between a receiver and a satellite intersects the atmospheric layer as shown in FIGS. 3A and 3B) and/or pierce angles.

S200 can include determining the parameters (and/or hyperparameters) associated with the GNSS corrections model S220. S220 functions to determine the values of the parameters and/or hyperparameters used by the GNSS corrections generation model based on the reference data input. S220 can use reference data (e.g., a subset of the dataset, a separate reference dataset, a dataset that partially overlaps the data set, etc.), past parameter estimates (raw estimates, smoothed estimates, posterior state values, etc.), and/or any suitable data to determine GNSS correction model parameters.

In preferred variants of S200, a sparse Gaussian process using the PIC assumption can be trained to determine the GNSS corrections (particularly but not exclusively ionospheric delay). In a specific example of such as sparse Gaussian process, the full set of training data (with N points, where N is a positive integer, such as all satellite observations from all base stations, all satellite observations associated with satellites above a threshold elevation from all base stations, all satellite observations associated with a given satellite or satellite constellation from all reference stations, etc.) can be used to compute a reduced-rank distribution (which can be represented as the covariance of a set of M inducing points, where M is a positive integer). Using these assumptions, an approximate computation scaling time for training the model is O(NM²+M³), after which predictions (e.g., in S300) can happen in time O(M²) (where O is referencing big O notation referring to ‘of the order of’ or ‘scales as’). In this specific example, the training data is assumed to occur in groups of correlated points which are independent of each other. In other variations, the groups of correlated points are further assumed to be independent of any predicted distributions (these variations are typically referred to as PITC). These variations can be used together. For instance, to make predictions for points correlated with a group of training data, the PIC approximation can first compute the PITC prediction, correct the PITC prediction by adding in information from the correlated training data, and removing information that this correlated training data contributed to the inducing point distribution (e.g., to avoid double-counting the information from the training data that was incorporated into the inducing points). In some tiled variants, the plurality of ionosphere observables is partitioned into a plurality of groups based on the plurality of geographic tiles, such that each group includes ionosphere observables whose pierce points (and/or reference stations) fall within a corresponding geographic tile (as described for instance in U.S. patent application Ser. No. 18/512,590 titled ‘SYSTEM AND METHOD FOR DETERMINING GNSS POSITIONING CORRECTIONS’ filed 17 Nov. 2023 which is incorporated in its entirety by this reference). In such variants, fitting the set of parameters of the regression model comprises fitting a sparse Gaussian process model under a partially independent conditional (PIC) assumption or a partially independent training conditional (PITC) assumption, where inter-group coupling is mediated through inducing variables while within-group structure is retained (PIC) and/or approximated (PITC).

In some variants that use a sparse Gaussian process, the predictive performance of the model can depend on the choice of inducing points (e.g., number, arrangement of, etc.) and/or groups of correlated data (e.g., how are the groups delineated, how many groups are there, etc.). For modelling a contribution to atmospheric effects to satellite signals, the groups of correlated data are preferably delineated spatially (e.g., based on a geographic region). However, the groups can additionally or alternatively be delineated based on observation type (e.g., pseudorange vs carrier frequency), satellite (e.g., satellite signal frequency, satellite elevation angle, satellite constellation, satellite bias, etc.), based on data sources within the group (e.g., number of reference or base stations within a spatial region, number of rovers within a region, etc.), and/or other suitable grouping(s) could be used. Examples of spatial groupings include (but are not limited to) rectangular grids, triangular grids, hexagonal grids, irregular grids (e.g., a grid that fully tiles a space but where each tile can have a different size and/or shape), Voronoi cells (e.g., formed relative to locations of data sources), Delaunay triangulation (e.g., formed relative to locations of data sources), and/or other suitable tessellations can be used. In preferred examples, a data source can be defined to a spatial group (of the set of spatial groups) based on a location of the data source. In another preferred example, a data source and/or data therefrom can be defined to a spatial group from the set of spatial groups based on a mean pierce point location. In yet another example, the spatial groupings can be determined or created based on the number of satellite observations typically observed at a data source (e.g., so that each grouping has approximately the same number of data sources or data recordings). In some variants, the spatial groupings (and/or other types of groupings) could be defined or generated using a k-d tree, octree, and/or other tree structure. However, data sources (and/or data derived therefrom) can otherwise be associated with (e.g., assigned to) a spatial grouping from the spatial groupings. In variants, the geographic region is partitioned into a plurality of geographic tiles, and the warping function is piecewise-defined over the plurality of geographic tiles. In such variants, adjacent tiles share boundary constraints on the warping function to reduce discontinuities across boundaries of the plurality of geographic tiles (e.g., by enforcing continuity of the mapping and/or continuity of first derivatives along shared boundaries). In some implementations, the piecewise-defined warping is optimized jointly across tiles (e.g., using shared parameters and/or boundary penalty terms) so that warped-domain coordinates remain consistent across the geographic region.

While not required for all variants, the Gaussian model can include shared inducing variables (also referred to as inducing points, inducing features, localized groups, etc.). The inducing variables can provide a technical advantage of improving continuity between different groupings (e.g., when the Gaussian process is broken into different groupings that are assumed to be independent such as spatial groupings). As such, the locations of the inducing variables are preferably selected such that boundary discontinuities are small (e.g., result in small differences in estimated GNSS errors across the boundary such as <5 cm, <2.5 cm, <2 cm, <1 cm, <0.5 cm, <0.25 cm, <0.2 cm, <0.1 cm, etc.). In an illustrative example, when the model partitions a geographic region into a plurality of tiles and assumes measurements are independent across tiles conditional on the inducing variables, a first subset of inducing variables can placed on and/or proximal to boundaries between adjacent tiles (and/or at shared corners of a plurality of tiles), which can reduce discontinuities by coupling neighboring tiles through common latent variables. Another technical advantage that can be conferred by the inducing points is that the inducing points can enable satellite hardware bias and/or other error sources (e.g., satellite clocks, satellite orbits, carrier phase ambiguities, SDBs, etc.) across or between groupings. In some variants that do not include inducing points, the absence of a mechanism for sharing estimates of error sources between groupings can be a source of discontinuities in estimated error between groupings.

Each inducing point preferably corresponds to one or more variables (e.g., state, effects, errors, etc.) related to a data source where data observed by the data source is weakly correlated or uncorrelated with data from other data sources. However, inducing points can correspond to variables of a cluster of data sources (e.g., where the cluster of data sources are weakly or uncorrelated with other data sources and/or clusters of data sources) and/or to any data source. The variable can correspond to a subset of times (e.g., the time associated with a batch of satellite observations, a subset of times associated with a batch of satellite observations, times not associated with a batch of satellite observations, etc.), the entire time over which observations have been made, and/or any suitable time. In variants, the inducing points can include each variable associated with a data source. However, one or more variables associated with a data source can be excluded (e.g., to be accounted for by the Gaussian process), and/or the inducing points can include any suitable variable(s).

The inducing points can correspond to hardware bias for one or more reference station, clock errors for one or more reference station, atmospheric effects (e.g., ionosphere delay, troposphere delay, ionosphere gradient, etc.) associated with sets or clusters of reference stations, clock errors associated with one or more satellite, hardware bias errors associated with one or more satellite, orbital errors associated with one or more satellite, errors associated with one or more satellite constellations, hardware bias associated with a GNSS receiver, clock errors associated with a GNSS receiver, errors or effects associated with sensors, and/or any suitable effect or error associated with any data source(s).

In a first illustrative example, each inducing point can correspond to variables related to one or more reference stations of the set of reference stations.

In a second illustrative example, variables (e.g., observations; satellite states such as satellite orbit, satellite clocks, satellite biases, etc.) relating to each satellite (e.g., in-view satellite) can correspond to an inducing point. In a variant of the second example, each satellite constellation can correspond to an inducing point.

In a third illustrative example, atmospheric effects (e.g., ionosphere delay, ionosphere gradient, troposphere delay, etc.) can be excluded from the set of inducing points (e.g., to be accounted for implicitly by the Gaussian process).

In a fourth illustrative example, the inducing point set can be the set of satellite hardware biases.

In a fifth illustrative example, the inducing point set can be the vertical total electron count estimate at the intersection of spatial groupings.

In a sixth illustrative example, the inducing variables correspond to a volumetric representation of the ionosphere, wherein an inducing variable represents an electron-density value and/or an electron-density coefficient for a volumetric region (e.g., a voxel, finite element cell, prism, basis-function support region, etc.) rather than a slant delay (or TEC) at a single (x,y,z,t) point. In the sixth illustrative example, slant ionospheric delays (and/or STEC/VTEC values) can be generated by integrating and/or aggregating the volumetric inducing variables along a line-of-sight path through the volumetric regions (optionally with mapping-function weighting), thereby enabling tomographic and/or multi-shell estimation using region-wise inducing variables.

However, any variables can be included or excluded from the set of inducing points.

The inducing points can be placed on a grid, placed relative to groupings (e.g., proximal or on boundaries between groupings), coincide with or be set relative to (e.g., anti-coincide with) data source locations, be placed at predetermined locations that result in enhanced model performance, and/or can otherwise be set. In preferred tiled variants, locations of inducing points are selected based on the plurality of geographic tiles, including placing a first subset of inducing points on boundaries between adjacent geographic tiles to promote continuity of predicted corrections across tile boundaries and to reduce boundary artifacts in PIC/PITC-style inference. Additional inducing points can be placed within tile interiors (e.g., on a grid, at corners where multiple tiles meet, and/or adapted to measurement density), and inducing point density can be increased in tiles with higher measurement throughput and/or higher expected ionospheric variability. As a first specific example (as shown in FIG. 5A), the inducing points can be placed along a boundary between groupings. As a second specific example (as shown in FIG. 5B), inducing points can be placed on a grid of locations that can correspond with the spatial groupings (e.g., at corners or points where a plurality of groupings coalesce). The second specific example is hypothesized to have improved performance (in terms of accuracy or fidelity of the model) by having the separate spatial groupings agree on a spatial field at a coarse, large scale and facilitating variations within a spatial grouping to be determined based on data within that spatial grouping. As a third specific example (as shown in FIG. 5C), inducing points can be placed on both sides of a spatial grouping boundary (e.g., a fixed distance from the boundary such as 50 m, 100 m, 200 m, 500 m, 1 km, etc.). As a fourth specific example, inducing points can be set using spectral (e.g., Fourier) features of total electron count (slant total electron count, vertical total electron count, etc.). However, inducing points can otherwise be placed (e.g., at random or quasi-random positions, within a threshold distance of features such as data sources or spatial grouping boundaries, etc.).

Note, that while inducing points can be in the same space and/or domain as the satellite observations and/or GNSS corrections, this need not be the case. For instance, the inducing points could represent spatial or temporal frequency modes (which could provide a technical advantage in some variants of improving global consistency between local spatial regions).

In some variants, the system can support localized spectral decompositions that can enable fast per-receiver correction determination (e.g., evaluation) while preserving a global and/or regional fit. The region fitted by an atmospheric model can be divided into cells or tiles, where each tile's spatial area is parametrized by a set of localized spectral basis

$$\{ {ϕ}_{j}^{*} \} .$$

Examples of spectral basis functions that can be used include: a 2-D product-of-strings basis (e.g., sines, cosines, etc.), a disc/drum-head basis (e.g., Bessel functions, modified Bessel functions, Hankel functions, spherical Bessel functions, modified spherical Bessel functions, spherical Hankel functions, etc.), a localized spherical basis (e.g., solid harmonics, spherical harmonics, zonal spherical harmonics, cubic harmonics, spherical cap basis functions, Slepian spherical harmonics, etc.), and/or any suitable orthogonal basis functions (e.g., Airy functions, orthogonal polynomials, etc.). In the general case, translation between a regional spectral model (basis {φᵢ}) and a tile-local spectral model

$$( basis \{ {ϕ}_{j}^{*} \} )$$

is not available in closed form; accordingly, the system computes a cross-covariance matrix to transform between the spectral models. In particular, the cross-covariance can be defined by an inner product integral over the tile domain, and approximated using quadrature points Q⊂Ω, such that K_{u,u*}≈Φ(Q)^{T}Φ*(Q). However, the cross-covariance can otherwise be defined. Translating a mean and covariance of the regional model to each tile's local spectrum can be performed (e.g., once per model update); then user corrections can be produced cheaply for any number of users with tile-local evaluation cost.

In some variants, determining the GNSS corrections model S200 includes determining a spectral decomposition of an atmospheric field (e.g., ionosphere delay, VTEC, STEC, shell-parameterized electron density, etc.) to reduce computational cost and improve scalability while preserving global consistency. The spectral approach can be used as an alternative to, or in combination with, sparse Gaussian process approximations such as PITC/PIC. In a spectral ionosphere variant, the system receives GNSS measurements from a set of reference stations, determines a plurality of ionosphere observables from the GNSS measurements, and determines, for each ionosphere observable, a corresponding pierce point on an ionospheric layer (and/or atmospheric shell). The system selects a spectral basis defined over a portion of a spherical surface corresponding to the ionospheric layer and represents an ionospheric delay field as a truncated spectral expansion comprising a weighted sum of K spectral basis functions and a corresponding set of K weights, wherein K is an integer less than a number of ionosphere observables used for fitting. The system estimates the set of K weights using the ionosphere observables and the spectral basis functions evaluated at corresponding pierce points. The system then generates ionospheric corrections for a mobile receiver by determining, for the mobile receiver and for each satellite in view, a receiver pierce point on the ionospheric layer and evaluating the truncated spectral expansion at the receiver pierce points to produce ionospheric delay estimates for the mobile receiver.

Spectral modeling preferably includes: selecting coordinates that represent spatial proximity and correlation relationships among model inputs (e.g., relationships between locations of reference stations, pierce points, and/or receiver locations and corresponding correction values), converting model inputs into this space, truncating the basis (e.g., by discarding less important spectral dimensions) to reduce model size; and/or approximating the original spatial model at lower computational cost.

In a first variant, S200 represents a spatial kernel k(⋅,⋅) using a truncated eigen-expansion (e.g., a Mercer-type truncation) such that

$$k ( x , {x}^{′} ) \approx {Σ}_{m = 1}^{M} {λ}_{m} {ϕ}_{m} ( x ) {ϕ}_{m} ( {x}^{′} ) ,$$

where φₘ are basis functions (eigenfunctions) and λₘ are associated eigenvalues. The truncation order M is selected to trade off fidelity and compute (e.g., based on explained spectral mass, expected length-scales, and/or measured validation residuals). In variants, the spectral basis can be generated from a set of orthonormal basis functions defined over the portion of the spherical surface (e.g., orthonormal under an inner product restricted to the geographic region and/or tile). In a preferred regional ionosphere implementation, the spectral basis comprises Slepian spherical harmonic basis functions that are orthonormal over the portion of the spherical surface. Truncating the spectral expansion can include selecting spectral modes based on corresponding eigenvalues by retaining spectral modes with eigenvalues above an eigenvalue threshold and excluding remaining spectral modes from the truncated spectral expansion. In further variants, the system precomputes and stores, for a grid of candidate pierce points on the portion of the spherical surface, a matrix of basis-function evaluations of the retained spectral modes, and uses the stored matrix to compute the set of K weights efficiently (e.g., by lookup/interpolation and/or by reusing precomputed design-matrix components).

In an illustrative example, the system models an atmospheric correction field f(x) in the warped coordinate system using a truncated basis expansion:

$$f ( x ) = {\sum }_{m = 1}^{M} {a}_{m} {ϕ}_{m} ( x ) ,$$

where {φₘ} are basis functions (e.g., localized harmonics, product-of-strings basis, windowed Fourier basis, and/or other orthogonal functions on the warped domain) and aₘ are coefficients to be estimated from measurements. Given N ionosphere observables {yᵢ} associated with warped-domain inputs {xᵢ}, the system forms a design matrix Φ∈R^{N×M} with Φ_{i,m}=φₘ(xᵢ) and estimates coefficients by minimizing an objective such as:

$${‖ y - Φa ‖}_{2}^{2} + λ {‖ a ‖}_{2}^{2}$$

(and/or an equivalent Bayesian objective where λ corresponds to a spectral prior on coefficients). Computationally, forming Φ (and/or per-measurement feature vectors) scales as O(NM) (e.g., computing M basis functions per measurement). In a first variation, when the basis is selected and discretized to be orthogonal under a quadrature rule (e.g., Φ^{T}WΦ≈I for a diagonal weight matrix W), coefficient updates decouple across modes and can be computed in time on the order of O(NM) (e.g., accumulating per-mode sufficient statistics and applying per-mode shrinkage), thereby avoiding construction or inversion of an N×N covariance matrix. In a second variation, the system computes the coefficient posterior (or ridge-regression solution) via a linear system in M unknowns; matrix-vector products with Φ enable iterative solvers whose dominant cost per iteration is O(NM), yielding total solve time on the order of O(I×NM) (optionally plus O(M²) for forming and/or applying a structured spectral prior). After the coefficients are determined, receiver-side evaluation can be performed by computing @ (xx) for a receiver pierce point x_{\*} and evaluating ƒ(x_{\*})=φ(x_{\*})^{T}a, which scales as O(M) per query for a predictive mean. In variants where the receiver (or server) additionally computes a predictive variance/confidence using an M×M coefficient covariance Σₐ, the variance computation scales as O(M²) (e.g., var[ƒ(x_{\*})]=φ(x_{\*})^{T}Σₐφ(x_{\*})). In this manner, the truncated spectral representation replaces dense GP inference with a computational profile dominated by O(NM) feature accumulation and O(M) (or O(M²) with uncertainty) per-user evaluation. However, the atmospheric correction field can otherwise be determined in the warped coordinate system.

In variants, the GNSS corrections model represents at least a portion of an atmospheric covariance kernel (e.g., a spatial angular kernel on a manifold, an Earth-fixed regional patch, and/or another spatial domain) using a spectral (Mercer) decomposition. In such variants, a spatial kernel can be approximated as a truncated sum of spectral modes, for example:

$$k ( x , {x}^{′} ) \approx {Σ}_{m = 1}^{M} S ( \sqrt{{λ}_{m}} ) {ϕ}_{m} ( x ) {ϕ}_{m} ( {x}^{′} ) ,$$

where φₘ(⋅) are eigenfunctions (basis functions) and λₘ are eigenvalues of a kernel operator on the chosen domain, and S(⋅) is a corresponding spectral density evaluated at modal frequencies related to λₘ. In an illustrative example, when the kernel is isotropic on a 2-D spatial domain, the spectrum can be represented using a scalar frequency argument; when the kernel is anisotropic, the spectrum can be represented as a product across dimensions aligned to kernel axes and/or via a numerical decomposition on data to determine the Mercer spectrum. In variants, the prior covariance for spectral coefficients is diagonal in the spectral domain, such that each retained spectral mode is assigned a corresponding prior variance. Assigning the corresponding prior variance can include determining the prior variance as a function of an eigenvalue associated with the retained spectral mode. For example, the system can derive a modal frequency from the eigenvalue (e.g., based on the eigen-operator for the chosen domain) and evaluate a kernel spectral density at the modal frequency to assign the mode's prior variance, thereby encoding expected smoothness and length-scale structure directly in the coefficient prior.

In variants, to form a multivariate Mercer approximation, the spectral density can be constructed as a product of per-dimension spectra, and the eigenbasis can be constructed as a product of per-dimension eigenfunctions, thereby enabling a structured basis expansion across multiple independent dimensions (e.g., latitude and longitude, latitude/longitude plus altitude, etc.).

In variants, a warping transform can be applied to spatial coordinates (e.g., pierce point coordinates and/or receiver-relative coordinates) prior to evaluating om (.), such that the spectral basis is evaluated on a warped manifold (e.g., to reduce nonstationarity and/or to locally equalize characteristic length scales).

In a preferred ionosphere implementation, the basis functions comprise spherical harmonics (global basis), spherical-cap harmonics (regional basis), windowed/tapered harmonics (e.g., Slepian tapers), and/or localized manifolds such as a disc (‘drum-head’) or a product-of-strings basis per tile. In variants, the spectral basis or basis function is truncated by retaining a selected subset of basis functions (spectral modes) and excluding remaining basis functions, thereby reducing model dimension and computational cost while preserving a target level of spatial fidelity. Truncating the spectral basis can include selecting a truncation order that limits the number of retained spectral modes, wherein the truncation order can be expressed as a maximum spherical-harmonic degree (and/or order), a maximum mode index, a maximum modal frequency, and/or an eigenvalue or spectral-concentration threshold, and retaining a corresponding subset of basis functions while excluding remaining basis functions from the truncated expansion. In variants, the number of retained modes M (and corresponding coefficient weights) is selected based on a target spatial resolution, a target compute budget, and/or a spectral-mass criterion (e.g., retaining modes that collectively account for at least a threshold fraction of spectral density or variance). For spherical-harmonic families, the truncation order can be expressed as a maximum degree L, wherein retaining degrees up to L retains on the order of (L+1)² modes (with regional/cap variants retaining a comparable number of modes for a given effective resolution). For Slepian or other windowed bases, truncation can include retaining the subset of taper functions whose concentration eigenvalues exceed a threshold (and excluding tapers below the threshold), thereby retaining modes that are best localized to the geographic region or tile. For localized bases (e.g., disc eigenfunctions or product-of-strings), truncation can include retaining the first J modes sorted by eigenvalue (spatial frequency) or by expected contribution under a spectral prior, and excluding higher-index modes. In one example, for a Matérn kernel (e.g., v=5/2), a degree-20 harmonic basis (441 modes) captures on the order of ~90% of spectral density and a degree-30 basis (961 modes) captures on the order of ~98%, such that increasing beyond degree 20-30 yields diminishing returns depending on target length-scales. However, an alternative degree of harmonic basis can be selected. In further variants, truncation can be implemented by assigning decreasing prior variance or stronger regularization to higher-degree modes, which suppresses higher-order components even when they are included in the candidate basis.

In variants, the spectral basis and truncation correspond to a target spatial resolution; for example, a degree-30 approximation can correspond to a half-wavelength on the order of hundreds of kilometers, and a regional/cap basis can substantially shorten effective wavelengths (e.g., to capture finer structure when needed) without requiring a full global expansion.

In some variants, spectral inducing points are used within a sparse Gaussian process formalism by defining inducing variables as spectral modes (rather than as spatial inducing points). This can provide improved global consistency as compared to inducing sets that are too local (e.g., purely slant-TEC-feature-based), and can improve scalability and boundary alignment when the model is partitioned into regions or tiles.

In some variants, for testing and verification, the system compares covariance matrices generated by a spatial kernel to covariance matrices generated by a truncated spectral expansion. In such tests, eigenvalues of the truncated spectrum can optionally be normalized (e.g., by an order-wise eigenvalue sum) to improve agreement between spatially generated and spectrally generated covariance volumes, wherein such normalization has negligible effect on fitted predictions but improves interpretability of offline comparisons.

In some variants, determining the GNSS corrections can include rebasing (and/or updating) the inducing points of the GNSS corrections model, which can be particularly, but not exclusively, beneficial for sparse Gaussian processes and modeling temporal processes therewith. Rebasing the inducing points functions to translate a set of inducing points, u, and to be relative to some new inducing points, z. Rebasing the inducing points can include switching inducing points by predicting the prior for the new inducing points then recomputing the quantities stored in a fit.

In variants, the GNSS corrections model includes a temporal covariance term defined between spectral modes at different times (e.g., between coefficients of the spectral basis expansion across epochs). In such variants, the temporal covariance for spectral coefficients can be scaled with elapsed time in a manner analogous to time scaling used for spatial measurements, enabling rebasing of spectral inducing points (e.g., spectral coefficients) to fit future epochs and enabling temporal TEC modeling. In a specific variant, the spectral coefficients (e.g., the set of retained-mode weights) can evolve according to a Markov temporal model, such that coefficients at a current epoch depend on coefficients at a prior epoch and a process-noise term. In such variants, updating the set of K weights across epochs can be performed using a Markov temporal model over the set of K weights, enabling temporal smoothing and streaming updates. For example, the system can model a coefficient vector wₜ at epoch t using a first-order Gauss-Markov process w_{t+Δt}=A(Δt)wₜ+ηₜ, where A(Δt) is a transition operator (e.g., diagonal or block-diagonal across modes and/or shells) and ηₜ is temporally white process noise with covariance Q(Δt). In such variants, A(Δt) can decay higher-frequency modes faster than lower-frequency modes (e.g., by using per-mode time constants), thereby encoding mode-dependent temporal smoothness and yielding a temporal covariance structure between spectral modes across epochs. The system can “rebase” by propagating a prior mean and covariance of the spectral coefficients forward in time using the Markov model and then updating the propagated coefficients using newly received ionosphere observables (e.g., via a Kalman-style measurement update and/or regularized regression update), thereby enabling time-evolving TEC modeling without refitting from scratch at each epoch.

Outputs from the GNSS correction model can include: GNSS corrections (e.g., accounting for one or more effect and/or error), residuals in the GNSS corrections, confidence in the GNSS corrections (e.g., predicted accuracy and/or integrity of the determined mobile receiver position using the GNSS corrections, likelihood that the GNSS corrections are correct, etc.), carrier phase ambiguities (e.g., fixed integer ambiguities, float ambiguities, etc.), outliers (e.g., outliers in the input data), and/or any output.

In some spectral variants, a single-epoch fit can be underdetermined in small spatial regions when the number of active measurements is small relative to the number of retained modes, particularly when the spectral basis spans a large region while measurements are geographically concentrated. Accordingly, in preferred variants, the system performs outlier detection using a dense local model (e.g., using the same kernel parameters as the spectral model) prior to (or alongside) fitting the spectral inducing variables. In further variants, once temporal propagation is enabled, well-resolved spectral inducing variables from a previous model update can be used for outlier detection even in small spatial regions. However, outlier detection may be omitted and/or can be performed in any suitable manner.

A covariance function preferably defines a relationship (e.g., correlation) between two or more variables (such as inputs to the Gaussian process). In specific examples, the covariances can represent covariances between satellite observations at a reference station (e.g., per station covariances, per station bias, etc.), covariances between satellite observations from a single satellite (e.g., per satellite covariances, per satellite bias, etc.), covariances between satellite observations from a satellite constellation (e.g., per satellite constellation covariances), between satellite observations from different reference stations, covariances between satellite observations from different satellites, and/or between any satellite observations. The relationship can be a spatial correlation (e.g., how correlated the variables are in space), a temporal correlation (e.g., how correlated the variables are in time), a dependence (e.g., a model relating one input to another input), a kinematic correlation (e.g., a correlation in speed, acceleration, jerk, etc. of the variables), a frequency correlation (e.g., how correlated the variables are in frequency), a satellite correlation, a reference station correlation, a satellite constellation correlation, combinations thereof, and/or any suitable correlation. Two or more covariance functions can be combined through addition (and/or subtraction), multiplication (and/or division), exponentiation, convolution, and/or in any manner. In an illustrative example, particularly beneficial when combined or differenced satellite observations are used, covariance functions can be combined and/or differenced (e.g., in the same manner as the satellite observations are combined). For instance, when Wübenna-Melbourne combinations of satellite observations are used, the covariance functions can be combined in the same linear combination. However, the covariance functions can otherwise be combined.

The covariance can depend on a difference between the inputs, a magnitude of the difference between the inputs, a parametric function (e.g., a processed input, a function of the inputs, etc.), the inputs independently, a product of the inputs, and/or have any dependence on the inputs.

In variants, the covariance kernel used by the GNSS corrections model is decomposed into a sum of components including a spatial term and one or more bias terms, for example: k(x,x′)=kₛₚₐₜᵢₐₗ(\vec{x},\vec{x}′)+k_{receiver}(eₓ,e_{x′})+k_{source}(sₓ,s_{x′}).

In variants, when observations are ordered (e.g., grouped) by receiver identifier and/or source identifier, a bias kernel (e.g., receiver bias kernel) can have block-diagonal structure and can be expressed as a symmetric product K_{receiver}=QQ^{T}, optionally up to a symmetric permutation P (e.g., K_{receiver}=P^{T}QQ^{T}P). In such variants, the overall kernel matrix can be expressed as a sum of symmetric products (including the spatial spectral term), which enables treating bias terms as additional inducing-point-like columns in an augmented system.

In some variants, the augmented measurement matrix used by the solver can include dense spatial/spectral columns (e.g., basis components) while bias columns (e.g., per-station and/or per-satellite) are sparse, wherein each measurement row has a limited number of nonzero bias entries. This structure can yield increased sparsity as the network grows (e.g., more bias columns relative to spatial columns), thereby improving computational efficiency for sparse linear algebra routines.

In a first illustrative example, a covariance function can depend on a distance function, which determines a distance between two locations. Examples of distance functions include: Euclidean distance, great circle distance, geodesic distance, Chebyshev distance, Manhattan distance, Minkowski distance, and/or any distance metric or function. The distance function is preferably a radial basis function, but can include a spherical basis function, azimuthal basis function, altitude basis function, zenith basis function, and/or any basis functions.

In a second illustrative example, a covariance function can depend on (and/or include) a mapping function (e.g., m(p)), which functions to correct for the distance that a signal (e.g., satellite observation) spends in a spatial region. Examples of mapping functions include: obliquity (e.g., m(p)=sec(θᵢ) where θᵢ is the angle that the signal intersects the shell relative to a reference axis such as an axis normal to a shell, normal to the surface of the earth, vertical axis, horizontal axis, etc.), Niell mapping functions, Isobaric mapping functions, Vienna mapping functions, Global mapping functions, hydrostatic mapping function, wet mapping function, and/or any suitable mapping function.

Examples of covariance functions include: constant functions, polynomial (e.g., linear, quadratic, piecewise smooth polynomials, etc.) functions, white noise functions, Kronecker delta (or Dirac delta function) functions, squared exponential functions, Ornstein-Uhlenbeck (e.g., Brownian) functions, (e.g., with variable drift terms that are dependent on the current value of the process), Wiener functions, Matérn functions, Bessel functions, periodic functions, rational (e.g., rational quadratic) functions, y-exponential functions, neural network covariance functions, and/or any suitable covariance function.

In a first specific example, a covariance function for a satellite and/or receiver (e.g., reference stations, mobile receiver, etc.) error (such as a hardware bias, clock error, orbit error) can be an Ornstein-Uhlenbeck function such as:

$${c}_{e r r o r} ( {z}_{i} , {z}_{j} ) = {σ}_{e r r o r}^{2} {e}^{- {α}_{e r r o r} \vert {t}_{i} - {t}_{j} \vert}$$

Where zᵢ and zⱼ are two observations corresponding to times tᵢ and tⱼ respectively, and

$${σ}_{e r r o r}^{2}$$

and αₑᵣᵣₒᵣ are hyperparameters which represent the total variance explained by the station clock and the time scale which indicates how much “memory” the station clock has or how quickly it de-correlates respectively.

In a second specific example, a covariance function for a satellite and/or receiver (e.g., reference stations, mobile receiver, etc.) error (such as a hardware bias, clock error, orbit error) can be a squared exponential function such as:

$${c}_{e r r o r} ( {z}_{i} , {z}_{j} ) = {σ}_{e r r o r}^{2} {e}^{- {{α}_{e r r o r} ( {t}_{i} - {t}_{j} )}^{2}}$$

In a third specific example, a covariance function for a satellite and/or receiver (e.g., reference stations, mobile receiver, etc.) error (such as a hardware bias, clock error, orbit error) can be a sum of an Ornstein-Uhlenbeck function and a squared exponential function such as:

$${c}_{error} ( {z}_{i} , {z}_{j} ) = ( {σ}_{error , ORN}^{2} {e}^{- {α}_{error , ORN} \vert {t}_{i} - {t}_{j} \vert} + {σ}_{error , GAU}^{2} {e}^{- {{α}_{error , GAU} ( {t}_{i} - {t}_{j} )}^{2}} )$$

Where the relative magnitudes of the hyper parameters

$${σ}_{error , GAU}^{2} and {σ}_{error , ORN}^{2}$$

can be related to the relative contribution of the processes to the error, where

$${σ}_{error , GAU}^{2} + {σ}_{error , ORN}^{2} = {σ}_{e r r o r}^{2} ,$$

and where α_{error,ORN} and α_{error,GAU} can have any relation. However,

$${σ}_{error , GAU}^{2} and {σ}_{error , ORN}^{2}$$

can be related in any manner.

In a fourth specific example, a position covariance function can be a polynomial covariance function such as:

$${c}_{p o s} ( {z}_{i} , {z}_{j} ) = {σ}_{p o s}^{2} {u}_{i}^{T} {u}_{j}$$

Where uᵢ is the unit vector pointing from the receiver to the satellite observed by observation zᵢ.

In a fifth specific example, a covariance function can include a term such as:

$${c}_{e r r o r} ( {z}_{i} , {z}_{j} ) = IsSameFreq ( {z}_{i} , {z}_{j} )$$

$${c}_{e r r o r} ( {z}_{i} , {z}_{j} ) = IsSameType ( {z}_{i} , {z}_{j} )$$

$$Or , {c}_{e r r o r} ( {z}_{i} , {z}_{j} ) = IsSameSource ( {z}_{i} , {z}_{j} )$$

where IsSameX(zᵢ,zⱼ) returns 1 if true and 0 if false, where Freq refers to the carrier frequency corresponding to the satellite observation (e.g., the L1, L2, L5, E1, E5a, E5b, E5ab, E6, G1, G2, G3, B1, B2, B3, LEX, etc. frequencies), Type refers to the type of satellite observation (e.g., pseudorange, carrier phase, code, etc.), and Source refers to the data source (e.g., reference station, mobile receiver, satellite, satellite constellation, etc.).

In a sixth specific example, an atmospheric covariance function (e.g., an ionosphere or troposphere covariance function) can be a squared exponential function (e.g., gaussian, radial basis function) such as:

$${c}_{atm} ( {p}_{i} , {p}_{j} ) = {σ}_{atm}^{2} {e}^{- {α}_{atm} {d ( {p}_{i} , {p}_{j} )}^{2}}$$

$$Or {c}_{vert} ( {p}_{i} , {p}_{j} ) = {σ}_{vert}^{2} {e}^{- {α}_{v e r t} {h ( {p}_{i} , {p}_{j} )}^{2}}$$

Where pᵢ and pⱼ correspond to two pierce points (for example as shown in FIGS. 3A, 3B, and 3C), d(pᵢ,pⱼ) corresponds to a distance function between the two pierce points, and h(pᵢ,pⱼ) corresponds to a height difference between the two pierce points.

In a seventh specific example, an atmospheric covariance function (e.g., an ionosphere or troposphere covariance function) can be an Ornstein-Uhlenbeck function such as:

$${c}_{atm} ( {p}_{k}^{s} , {p}_{{k}^{′}}^{{s}^{′}} ) = {σ}_{atm}^{2} {e}^{- {α}_{a t m} \vert {p}_{k}^{s} - {p}_{{k}^{′}}^{{s}^{′}} \vert}$$

In an eighth specific example, an atmospheric covariance function (e.g., an ionosphere or troposphere covariance function) can be a product of a mapping function (e.g., m(x)) and a covariance function such as:

$${c}_{s h e l l} ( {p}_{k}^{s} , {p}_{{k}^{′}}^{{s}^{′}} ) = m ( {p}_{k}^{s} ) * {c}_{atm} ( {p}_{k}^{s} , {p}_{{k}^{′}}^{{s}^{′}} ) * m ( {p}_{{k}^{′}}^{{s}^{′}} )$$

where

$${c}_{atm} ( {p}_{k}^{s} , {p}_{{k}^{′}}^{{s}^{′}} )$$

can represent the correlation between the electron content at two different points in space.

$$m ( {p}_{k}^{s} )$$

can represent the obliquity

$$( m ( {p}_{i}^{s} ) = 1 / cos ( {θ}_{i} ) ,$$

where θᵢ is the angle at which a signal intersects the shell (e.g., relative to vertical), and/or be any other suitable mapping function.

In a ninth specific example, an atmospheric covariance function can be a convolution of covariance functions such as:

$${c}_{atm \_ multiple} ( {I}_{1 , k}^{s} , {I}_{1 , {k}^{′}}^{{s}^{′}} ) = {\sum }_{i}^{m} {\sum }_{j}^{m} {c}_{vert} ( {p}_{k , i}^{s} , {p}_{{k}^{′} , j}^{{s}^{′}} ) * {c}_{s h e l l} ( {p}_{k , i}^{s} , {p}_{{k}^{′} , j}^{{s}^{′}} )$$

Where

$${I}_{1 , k}^{s}$$

corresponds to the ionosphere delay 1250.

In a tenth specific example, an atmospheric covariance functions can be an Ornstein-Uhlenbeck function such as:

$${c}_{atm} ( {p}_{k}^{s} , {p}_{{k}^{′}}^{{s}^{′}} ) = {σ}_{atm}^{2} {e}^{- \frac{\vert {p}_{k}^{s} - {p}_{{k}^{′}}^{{s}^{′}} \vert}{{l}_{a t m}}}$$

Where lₐₜₘ is a hyperparameter corresponding to a length scale for the decorrelation of the pierce points. In this specific example, a mean of the covariance function can be given by:

$$μ ( {p}_{k}^{s} ) = {a}_{atm} + {I}_{k , model}^{s}$$

Where μ corresponds to the mean, aₐₜₘ corresponds to an inferred atmospheric offset, and

$${I}_{k , model}^{s}$$

corresponds to the value that a model (e.g., the klobuchar model of the ionosphere, klobuchar model, NeQuick model, BeiDou global broadcast ionospheric delay correction model [BDGIM], etc.) would give for the zenith ionosphere delay at location

$${p}_{k}^{s} .$$

In an eleventh specific example, the atmospheric model includes a Gaussian process that uses covariances that model: a per-satellite bias (e.g., even with high-precision clock/orbit products), a multi-shell model (e.g., multiple shells for all satellites, one shell per satellite, etc.), and the great circle distance. However, the atmospheric model can be otherwise modelled.

In a twelfth specific example, the covariance function can be a sum, product, convolution, and/or otherwise combine any or all of the covariance functions from the preceding examples (e.g., a sum of the c_{atm_multiple}, cₛₜₐₜᵢₒₙ, cₛₐₜₑₗₗᵢₜₑ). However, any covariance function can be used for any models and/or error(s).

In variants, the atmospheric model can include and/or correspond to a multi-shell model. The multi-shell model can refer to a plurality of shells, a shell associated with each satellite, a shell associated with each satellite constellation, and/or any suitable shells. Each shell of the multi-shell model can have the same or different thickness. However, the atmospheric model can include a single shell, model the atmosphere continuously, and/or otherwise model the atmosphere.

In multi-shell variants, the spectral representation can be ordered by mode such that inter-shell correlations are confined to per-mode blocks. For example, for each spectral mode m, shell-to-shell correlations can be represented by a small matrix block

$${Λ}_{m}^{*}$$

whose off-diagonal entries encode radial correlations between shells, yielding an efficiently invertible prior distribution by inverting many small matrices (e.g., 2×2, 3×3) rather than a single large dense matrix. In multi-shell spectral variants, the ionospheric layer includes a plurality of atmospheric shells, and the system jointly estimates a respective set of K weights for each atmospheric shell using a cross-shell prior covariance that couples corresponding retained spectral modes between atmospheric shells. In one example, the per-shell coefficient vectors are stacked and the cross-shell prior covariance is structured to couple same-index (corresponding) retained modes across shells (e.g., yielding small per-mode cross-shell blocks that can be inverted efficiently), thereby enabling tomographic consistency while preserving computational scalability.

In variants using a multi-shell atmospheric model, radial (vertical) correlation between shells can be incorporated as a known function of inter-shell spacing, for example ρ=k_{radial}(hᵢ−hⱼ). In such variants, for two slant paths with pierce points on different shells, the cross-covariance can be written as a scaled angular covariance and expressed in a spectral form such as η[ΦₐΛΦ_{b}] (i.e., the angular eigenfunctions are shared while the radial coupling scales cross-shell covariance).

In further variants, the radial correlation term can be pushed “inside” the eigen-decomposition (e.g., into the eigenvalue structure Λ), enabling construction of a multi-shell spectral representation by concatenating per-shell eigenvalues and coupling them via radial correlation parameters.

However, the correction model can be otherwise selected.

Determining GNSS corrections S300 can function to generate a set of GNSS corrections using the GNSS corrections model (e.g., from S200). These corrections are preferably generated in a form usable by the receiver for which corrections are desired, but can additionally or alternatively be generated in any form. For example, when the receiver can accept PPP corrections, S300 can generate corrections in the form of PPP corrections (though, in contrast to true PPP corrections, the GNSS corrections generated by S300 may depend upon receiver position estimate or another spatial term). Additionally or alternatively, S300 can send corrections in the form of RTK corrections (e.g., of a virtual reference station, virtual satellite observations, etc.), RTK-PPP corrections, SBAS corrections, SSR corrections (e.g., state space representations reflecting different terms for different errors or combinations of errors), and/or in any other form (e.g., local coefficients that are part of a local model, global coefficients that are part of a global model, etc.). Note that local and global corrections may happen in any order (and may be synchronous or asynchronous). In variants, S300 includes outputting (and/or packaging) the fitted set of parameters of the regression model together with data defining the warping function, for example as part of a GNSS correction message and/or SSR payload. In such variants, a mobile receiver can determine a corrected slant ionospheric delay by: determining, for each satellite in view, a receiver pierce point on the ionospheric layer (or atmospheric shell); warping the receiver pierce point using the warping function; and evaluating the regression model at the warped receiver pierce point to compute a correction value. In variants, the warping function maps a geodetic coordinate and an epoch time into a geomagnetic coordinate system comprising geomagnetic latitude and magnetic local time, which can better align modeled correlation structure with geomagnetic forcing. In further variants, the corrected slant ionospheric delay is used to determine a positioning solution of the mobile receiver (e.g., PPP, RTK, RTK-PPP, or other positioning modes) by correcting receiver GNSS measurements using the generated ionospheric corrections.

S300 may include dynamically adjusting the models used to generate GNSS corrections in any manner. For example, S300 may include switching between models at any time based on changing conditions.

In some variants (e.g., when trying to predict a value at a point that is uncorrelated with all training data), the model can switch to using a PITC approximation (e.g., using only the inducing point distribution to predict the value at the uncorrelated point rather than using the spatial groupings).

In variants, S300 can include fixing the carrier phase ambiguity associated with one or more satellites in line-of-view of the receiver to an integer value. The carrier phase ambiguity can be fixed as part of the GNSS corrections model, as disclosed in U.S. patent application Ser. No. 16/817,196 titled “SYSTEMS AND METHODS FOR REAL TIME KINEMATIC SATELLITE POSITIONING,” filed 12 Mar. 2020 or U.S. patent application Ser. No. 16/865,077 titled ‘Systems and Methods for High-Integrity Satellite Positioning’ filed 1 May 2020 each of which is incorporated herein in its entirety by this reference, and/or can be otherwise fixed or constrained. In some embodiments of the method, the carrier phase ambiguity can be resolved (e.g., as a floating carrier phase ambiguity, as an integer carrier phase ambiguity, etc.), before the corrections are determined (e.g., to input the carrier phase ambiguity into the model for determining the corrections).

S400 includes transmitting the set of GNSS corrections. S400 functions to transmit the GNSS corrections to a mobile receiver (or other end point where the GNSS corrections can be used). GNSS corrections can be transmitted wirelessly (e.g., over a cellular, Wi-Fi, satellite, etc. network), over a wired connection, and/or in any manner. In a series of specific examples, the GNSS corrections can be transmitted in a form and/or manner as described in U.S. patent application Ser. No. 18/512,590 titled ‘SYSTEM AND METHOD FOR DETERMINING GNSS POSITIONING CORRECTIONS’ filed 17 Nov. 2023, U.S. patent application Ser. No. 18/117,879 titled ‘SYSTEM AND METHOD FOR PROVIDING GNSS CORRECTIONS’ filed 6 Mar. 2023, and/or U.S. patent application Ser. No. 18/665,225 titled ‘SYSTEM AND METHOD FOR GNSS CORRECTION TRANSMISSION’ filed 15 May 2024 each of which is incorporated in its entirety by this reference. In variants where the GNSS corrections are transmitted according to a tile, the tile is preferably compatible with the geographic or spatial subregions (e.g., the model is divided into subregions matching the transmission tiles, the tiles are selected to match the geographic subregions, etc.), which can be beneficial for facilitating continuity across tiles (e.g., without requiring significant changes to ensure said continuity). However, the subregions and tiles can be unrelated and/or have any suitable relationship (e.g., same geographic extent but offset relative to one another, same spatial area but the location of said area is not identical, etc.).

S500 includes correcting a position estimate using the set of GNSS corrections. The position estimate can be calculated at the mobile receiver, at a computing system (e.g., positioning module associated with a corrections generator), and/or at any suitable component. In some embodiments, it can be desirable for the position estimate to be calculated by the GNSS corrections generation source (while this may have higher latency, the GNSS corrections generation may in some cases be performed by substantially more powerful computers than positioning calculation at the receiver). In this case, S500 includes receiving a position estimate from a receiver and correcting this position estimate using the GNSS corrections generated in S300 (after which the corrected position may be transmitted back to the receiver and/or to any other location). In spectral variants, the system (and/or the mobile receiver) can determine a position solution of the mobile receiver based on (i) the ionospheric corrections generated for the mobile receiver from the truncated spectral expansion and (ii) GNSS measurements received by the mobile receiver, optionally jointly estimating position and ambiguity/bias states in a positioning filter.

The methods of the preferred embodiment and variations thereof can be embodied and/or implemented at least in part as a machine configured to receive a computer-readable medium storing computer-readable instructions. The instructions are preferably executed by computer-executable components preferably integrated with a system for GNSS corrections generation. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. A method for generating ionospheric Global Navigation Satellite System (GNSS) corrections, comprising:
receiving, from a set of reference stations, satellite observations corresponding to signals transmitted by a plurality of satellites;
determining, from the satellite observations, a plurality of ionosphere observables;
determining, for each ionosphere observable, a corresponding pierce point on an atmospheric shell, wherein the pierce point corresponds to an intersection between a line-of-sight path between a respective reference station and a respective satellite through the atmospheric shell;
applying a warping function that maps the spatial coordinates from an Earth-fixed coordinate system into a warped coordinate system with reduced spatial correlation anisotropy of ionosphere observables across a geographic region;
determining a spatial ionospheric correction field in the warped coordinate system by fitting a set of parameters of a regression model using the plurality of ionosphere observables; and
outputting the fitted set of parameters of the regression model and the warping function, wherein a mobile receiver determines a corrected slant ionospheric delay.

2. The method of claim 1, wherein computing the corrected slant ionospheric delay comprises:
determining a receiver pierce point corresponding to an intersection between a line-of-sight path between a GNSS receiver and a satellite-in-view of the GNSS receiver through the atmospheric shell;
warping the receiver pierce point using the warping function; and
evaluating the regression model at the warped receiver pierce point.

3. The method of claim 1, wherein the warping function maps a geodetic coordinate and an epoch time into a geomagnetic coordinate system comprising geomagnetic latitude and magnetic local time.

4. The method of claim 1, wherein the geographic region is partitioned into a plurality of geographic tiles, wherein the warping function is piecewise-defined over the plurality of geographic tiles, and wherein adjacent tiles share boundary constraints on the warping function to reduce discontinuities across boundaries of the plurality of geographic tiles.

5. The method of claim 4, wherein fitting the set of parameters of the regression model comprises fitting a sparse Gaussian process model under a partially independent conditional (PIC) assumption or a partially independent training conditional (PITC) assumption, wherein the plurality of ionosphere observables is partitioned into a plurality of groups based on the plurality of geographic tiles.

6. The method of claim 5, wherein the sparse Gaussian process model comprises a plurality of inducing points, and wherein locations of the inducing points are selected based on the plurality of geographic tiles, comprising placing a subset of inducing points on boundaries between adjacent geographic tiles.

7. The method of claim 1, wherein determining the warping function comprises optimizing parameters of the warping function to reduce a measured anisotropy metric of residuals of the ionosphere observables.

8. The method of claim 1, wherein the regression model comprises an isotropic radial basis function model in the warped coordinate system.

9. The method of claim 1, wherein determining the spatial ionospheric correction field comprises a regularization term, wherein the regularization term penalizes higher-order spectral components of a spectral decomposition of the spatial ionospheric correction field.

10. The method of claim 1, wherein the corrected slant ionospheric delay is used to determine a positioning solution of the mobile receiver.

11. A method for generating ionospheric GNSS corrections, comprising:
receiving, from a set of reference stations, GNSS measurements corresponding to signals transmitted by a plurality of satellites;
determining, from the GNSS measurements, a plurality of ionosphere observables;
determining, for each ionosphere observable, a corresponding pierce point on an ionospheric layer;
selecting a spectral basis defined over a portion of a spherical surface corresponding to the ionospheric layer;
representing an ionospheric delay field as a truncated spectral expansion comprising a weighted sum of K spectral basis functions and a corresponding set of K weights, wherein K is an integer less than a number of ionosphere observables used;
estimating the set of K weights using the ionosphere observables and the spectral basis functions; and
generating ionospheric corrections for a mobile receiver by:
determining, for the mobile receiver and for each satellite in view of the mobile receiver, a receiver pierce point on the ionospheric layer; and
evaluating the truncated spectral expansion at the receiver pierce points to produce ionospheric delay estimates for the mobile receiver.

12. The method of claim 11, wherein the spectral basis comprises generating the spectral basis from a set of orthonormal basis functions defined over the portion of the spherical surface.

13. The method of claim 12, wherein the spectral basis comprises Slepian spherical harmonic basis functions that are orthonormal over the portion of the spherical surface.

14. The method of claim 11, wherein the truncated spectral expansion is determined by selecting spectral modes based on corresponding eigenvalues, retaining spectral modes with eigenvalues above an eigenvalue threshold, and excluding remaining spectral modes from the truncated spectral expansion.

15. The method of claim 14, further comprising:
precomputing and storing, for a grid of candidate pierce points on the portion of the spherical surface, a matrix of basis-function evaluations of the retained spectral modes; and
using the stored matrix to compute the set of K weights.

16. The method of claim 11, wherein estimating the set of K weights comprises solving a regularized linear system using a prior covariance matrix for the set of K weights, wherein the prior covariance matrix is diagonal in a spectral domain such that each retained spectral mode is assigned a corresponding prior variance.

17. The method of claim 16, wherein assigning the corresponding prior variance comprises determining the corresponding prior variance as a function of an eigenvalue associated with the retained spectral mode, wherein determining the corresponding prior variance comprises evaluating a kernel spectral density at a modal frequency derived from the eigenvalue.

18. The method of claim 11, wherein the ionospheric layer comprises a plurality of atmospheric shells, and wherein estimating the set of K weights comprises jointly estimating a respective set of K weights for each atmospheric shell using a cross-shell prior covariance that couples corresponding retained spectral modes between atmospheric shells.

19. The method of claim 11, further comprising updating the set of K weights across a plurality of epochs using a Markov temporal model over the set of K weights.

20. The method of claim 11, further comprising determining a position solution of the mobile receiver based on the ionospheric corrections generated for the mobile receiver; and GNSS measurements received by the mobile receiver.
